(19) United States
(12) Patent Application Publication
(10) Pub. No.: US 2016/0006047 A1
(43) Pub. Date: Jan. 7, 2016

(54) SOFC STACK WITH INTEGRATED HEATER

(71) Applicant: HALDOR TOPSØE A/S, Kgs. Lyngby (DK)

(72) Inventor: Claus Friis Pedersen, Vanløse (DK)

(73) Assignee: Haldor Topsøe A/S, Kgs. Lyngby (DK)

(21) Appl. No.: 14/768,492

(22) PCT Filed: Mar. 3, 2014
(86) PCT No.: PCT/EP2014/054086

§ 371 Date: Aug. 18, 2015

(30) Foreign Application Priority Data
Mar. 11, 2013 (EP) PCT/EP2013/054871

(51) Int. Cl. H01M 8/04; H01M 8/12

(52) U.S. Cl. CPC H01M 8/04007; H01M 8/1246; H01M 8/04037; H01M 8/04014; H01M 2008/1293; H01M 2300/0071

(57) ABSTRACT

An integrated heater for a Solid Oxide Fuel System is integrated directly in the SOFC stack, and can operate and heat the stack independently of the process.

The present invention relates to a Solid Oxide Fuel Cell (SOFC) system with a heating unit. Particular it relates to an integrated heating unit for an SOFC system which improves the efficiency of the SOFC system by minimizing the heat loss of the system, more particular by dense mechanical integration of the heating unit with SOFC stacks to reduce heat-loss from piping and external heater surfaces.

Solid Oxide Cells can be used for a wide range of purposes including both the generation of electricity from different fuels (fuel cell mode) and the generation of synthesis gas (CO+H2) from water and carbon dioxide (electrolysis cell mode).

Solid oxide cells are operating at temperatures in the range from 600° C. to above 1000° C. and heat sources are therefore needed to reach the operating temperatures when starting up the solid oxide cell systems e.g. from room temperature.

For this purpose external heaters have been widely used. These external heaters are typically connected to the air input side of a solid oxide cell system and are used until the system has obtained a temperature above 600° C., where the solid oxide cells operation can start.

During the electrochemical operation of the solid oxide cell heat is typically produced in relation to the Ohmic loss

Q=R*I² (1)

Where Q is the heat generated, R is the electrical resistance of the fuel cell (stack) and I is the operating current.

Furthermore heat is produced or consumed by the electrochemical process as:

Q=F*k*I (2)

When k is the chemical energy for a given ‘fuel’ (e.g. the lower heating value for a given fuel) and F is Faradays number. By ‘fuel’ is here understood the relevant feedstock which can either be oxidised in fuel cell mode (e.g. H2 or CO) or be reduced in electrolysis mode (e.g. H2O or CO2).

In equation (2) heat is generated in fuel cell mode (positive sign of the current) and heat is consumed in electrolysis mode (negative sign of the current).

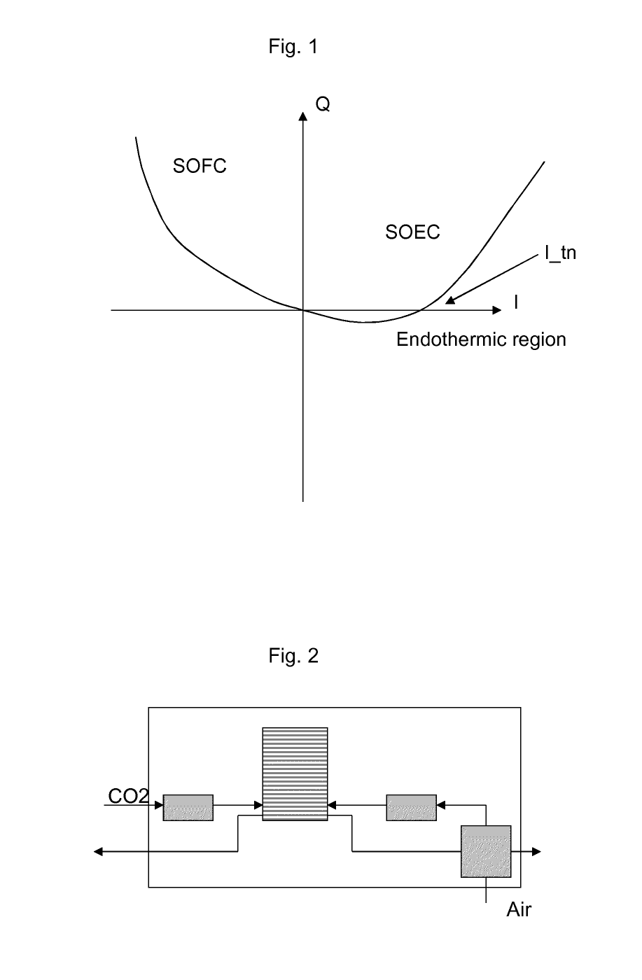

An example of the heat produced by the solid oxide cell or stack as function of current is shown in FIG. 1. Here it is seen that for all currents heat is produced in Solid Oxide Fuel Cell (SOFC) mode and for currents above I_tn heat is also produced in SOEC mode.

Here I_tn is the so-called thermo neutral current where:

R*I_{—}tn²+F*k*I_{—}tn=0=>I_{—}tn=F*k/R (3)

For SOFC in general and for SOEC systems operating above I_tn no additional heating elements are in general needed to maintain the desired operating temperature of a solid oxide cell system.

However for a system operating in SOFC mode additional heat sources operating at temperatures close to or above the stack operating temperature are needed in particular situations such as low load operation, or during start up or stand-by to maintain the necessary temperature.

This invention relates to such systems and methods for efficient mechanical design of such systems.

US20100200422 describes an electrolyser including a stack of a plurality of elementary electrolysis cells, each cell including a cathode, an anode, and an electrolyte provided between the cathode and the anode. An interconnection plate is interposed between each anode of an elementary cell and a cathode of a following elementary cell, the interconnection plate being in electric contact with the anode and the cathode. A pneumatic fluid is to be brought into contact with the cathodes, and the electrolyser further includes a mechanism ensuring circulation of the pneumatic fluid in the electrolyser for heating it up before contacting the same with the cathodes. Hence, US20100200422 describes the situation where heat has to be removed from the SOEC stack, where this invention relates to the opposite situation. It describes an invention where the heat exchanger (cooling) function is embedded between the cells. This invention relates to additional heater blocks placed outside the stack but within the stack mechanics to reduce the hot area of the stack and heaters.

EP1602141 relates to a high-temperature fuel cell system that is modularly built, wherein the additional components are advantageously and directly arranged in the high-temperature fuel cell stack. The geometry of the components is matched to the stack. Additional pipe-working is thereby no longer necessary, the style of construction method is very compact and the direct connection of the components to the stack additionally leads to more efficient use of heat. However EP1602141 is not in the technical field of SOEC and the particular problems related to SOEC. Especially the need for continuous and active heating of the cell stack during operation with a heating unit which is process independent of the SOEC and which operates at temperatures close to or above the stack operating temperature is not disclosed.

Hence, there is a need for an energy-efficient and economic heating unit for an SOFC system. This problem is solved by the present invention according to the embodiments of the claims.

As described above, in a system operating in SOFC mode additional heat is consumed during certain operation situations and additional SOFC-process independent heat sources are needed to maintain the necessary operating temperature.

For such systems reduction of heat loss is essential to an energy efficient operation as every Watt lost through heat dissipation into the surroundings has to be provided as additional energy and this heat loss will reduce the efficiency.

This invention relates to the reduction of heat-loss in a solid oxide system by mechanically integrating the heating elements together with the stack. For most high temperature designs, the heat loss is dominated by heat-loss from hot surfaces. This heat loss is proportional to the hot surface area

For the heaters used with SOFC and stacked cells, the hot surfaces in relation to heaters are:
The heater surface
Hot surface of any piping between the heaters and the solid oxide stack of cells

According to an embodiment of the invention, a solid oxide system comprises a planar solid oxide cell stack and a heating unit, wherein particularly said heating unit is an integrated part of the solid oxide system. Accordingly, as the heating unit is integrated, the heater surfaces are reduced, since at least some of the heater surfaces are directly connected to and therefore in close mechanical/physical contact to the surfaces of the SOFC stack. More particularly, instead of having two hot ends (top and bottom) of the SOFC stack and two hot ends of the heating unit (top and bottom), the heating unit can be incorporated within the SOFC stack and the total number of hot ends (surface) is reduced from four to two. Additionally the piping, which otherwise has a large surface to volume ratio and therefore a large heat loss, can be omitted, saving costs and particularly heat loss. The stack is planar, it comprises a plurality of stacked plates such as electrodes, electrolytes and interconnects and therefore it can be advantageous that also the heating unit is planar so it mechanically corresponds to the SOFC components. For instance the heating unit can comprise one or more flat plates where each plate has one or more heating elements.

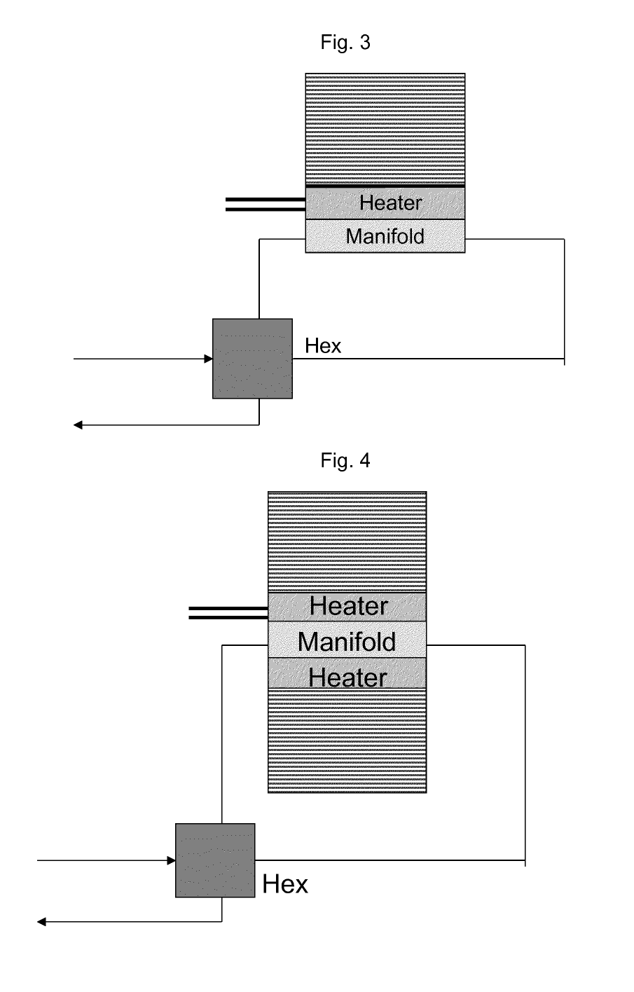

In a particular embodiment of the invention, the heating unit is directly connected to one end plate of the cell stack and the outer dimensions of the connected part of the heating unit corresponds to the outer planar dimensions of said end plate of the cell stack. Advantageously, the heating unit is connected to the face of an end plate which is opposite to the face of the end plate which is connected to the cell stack (see also FIG. 3). Thereby one face of the end plate is heated and the heat is then distributed to the SOFC stack by means of heat transmission within the end plate which is typically made of metal. In a variation of the embodiment, the heating unit may be connected to an end of the SOFC stack between an end plate and the stacked active components of the stack (electrolytes, electrodes and interconnects).

To achieve an SOFC system with a large capacity it is common to connect a plurality of SOFC stacks. In such a case, an advantageous embodiment of the invention is to arrange the heating unit between the ends of two SOFC stacks in a sandwich arrangement. This has the effect that the heat loss is even further reduced, since one end of the SOFC stack or the heating unit is connected to another stack in stead of facing the surroundings and further the costs are reduced since one heating unit is heating two stacks. In a variation of this embodiment, more than one, preferably two heating units are sandwiched between two SOFC stacks. This can be advantageous where the two stacks share another component, for instance a manifold, which can then be sandwiched between the two heating units. In this way, still two heating units are needed for two SOFC stacks, but the heat loss is reduced as compared to two separate stacks with heating units.

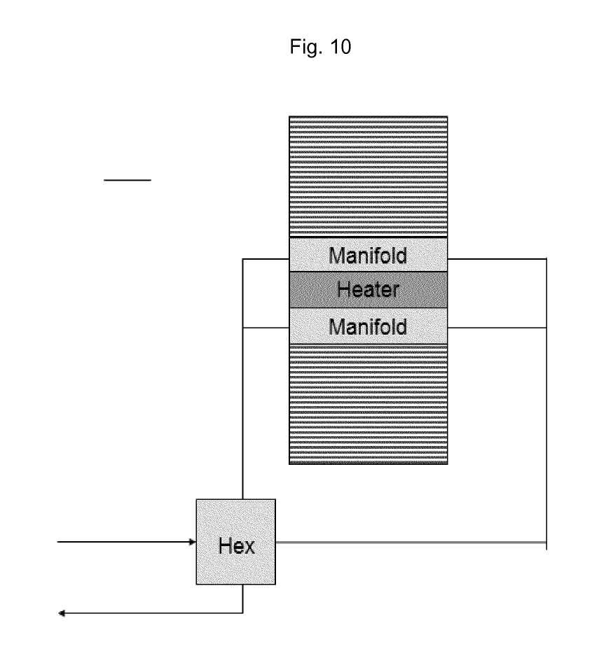

In a preferred embodiment a single heater is on both end facets connected to a manifolding plate which for example can be used for feeding input process gas to two stacks. In this way the hot input processes gases give a uniform heating of the cells in the stack, please see FIG. 10. By a process gas is here understood a gas fed to or exhausted by the SOFC cell stack on either the anode side or the cathode side of the SOFC cell stack.

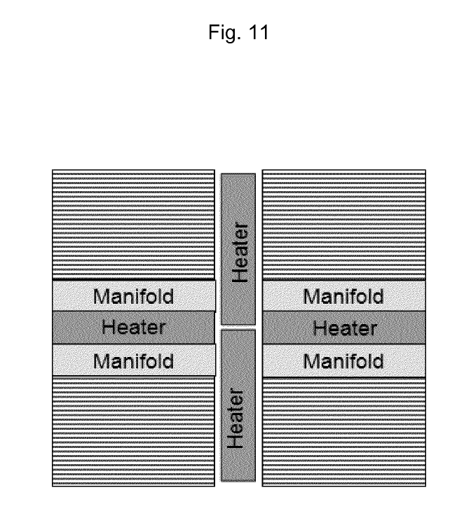

In another preferred embodiment individual SOFC stacks can be placed side by side to provide a compact large system. Here rectangular heaters can also be used between the sides of two stacks as shown in FIG. 11. If the heaters are placed on the side of the stack where input process gases are propagating, these will be heated and again provide a uniform distribution of heat across all cells in the stack,

According to the invention the heating unit may in one embodiment comprise an electrical resistance element. An important factor of this embodiment is that an electrical resistance element can operate and temperatures above the stack operating temperature and comprise the possibility of heating the SOFC stack independently of any process which may or may not take place in the SOFC stack, contrary to other disclosed solutions which rely on a process gas to transmit the heat (at temperatures below the stack operating temperature) to the stack (known gas pre-heaters or heat exchangers). As electricity is produced by the SOFC process, electricity may be available for the system. The SOFC system may be connected to an electrical grid where from electricity is available. An electrical resistance element provides easy control of the applied heat and compact physical dimensions. The heating unit comprising the electrical resistance element enables heat production when the SOFC stack is in operation as well as stand-by heat production when the SOFC stack is not in operation but a demand for short start-up time is present. In a variation of this embodiment, the heating unit further comprises an electrically isolating element serving to electrically isolate the electrical resistance element from the cell stack. This enables the use of metal heating elements which fit the thermo-mechanics of the SOFC stack well and are strong and relatively cheap without the risk of short circuiting. The electrically isolating element may be made of ceramics, providing electrically isolation as well as high temperature resistance.

In further particular embodiments, the heating unit comprises a ceramic heater or a chemical heater.

A chemical heater may according to an embodiment of the invention comprise a catalyst which enables combustion in the chemical heater at a lower temperature than the auto ignition temperature of a burner gas provided to the chemical heater. The burner gas may be a part of the gas provided to the SOFC.

In a further embodiment of the invention the heating unit is formed by an external manifolding for a process gas for the SOFC cell stack and the heating is performed by adding a so-called ‘burner gas’ in the external manifolding. The process gas may be the SOFC anode gas in which case the ‘burner gas’ would be an oxygen rich gas. The process gas may alternatively be the SOFC cathode gas in which case the ‘burner gas’ could be a fuel type gas such as for example H₂, CO, CH₄ or NH₃. This embodiment of the invention can advantageously be combined with the above embodiment comprising a catalyst.

In a further embodiment the heating unit is placed in the vicinity of the stack manifold where the input flows enter the stack. The heating unit will then heat up the input flows which again results in a uniform heating of the stack

The invention is further explained by the following examples with reference to the figures. Though the examples relates to electrolysis mode, the physical structures of the system relates also to fuel cell mode according to the invention.

An example of a traditional solid oxide electrolysis system is shown in FIG. 2. A solid oxide electrolysis stack is fed with H2O and/or CO2 through a heat exchanger and an electrical heating unit. The cold feed gas is first pre-heated in an input/output heat exchanger and is then heated to a temperature above the operating temperature (e.g. 850° C. for a stack operating at 750° C.) in an electrical heating unit.

The electrical heating unit providing for example 500 W at an output temperature of 850° C. can be constructed from Kanthal winded wire placed in a ceramic tube. This ceramic tube is then build into a cylindrical steel tube with a diameter of 7 cm and a length of 12 cm, corresponding to a surface area of 340 cm². Piping between the heating unit and the stack typically adds another 200 cm² of hot surface to give a total hot heating unit surface area of 540 cm².

In the present invention it is proposed to include the heating unit into the stack mechanics, for example as an electrical heating unit measuring 1.5×12×12 cm (corresponding to the SOFC stack planar dimensions, width=12 cm and depth=12 cm). In this case the open heating unit area would have a surface area of 12×(12+4×1.5)=216 cm² as shown in FIG. 3. As a figure of merit, the ratio between the heat ‘losing’ surface area and the heat transferring can be used. In this case it is (12×(12+4×1.5))/(12×12)=150%

To further reduce that surface area of the heating units it is also possible to place two stacks back to back with the electrical heating unit ‘sandwiched’ between the stacks as shown in FIG. 4. In this case the heating unit open surface is reduced to 12×4×1.5=72 cm² as shown in FIG. 4. In this embodiment the loss ratio becomes 25%. Furthermore, several sandwiched SOFC stacks can be arranged side by side, which further reduces the open surface area.

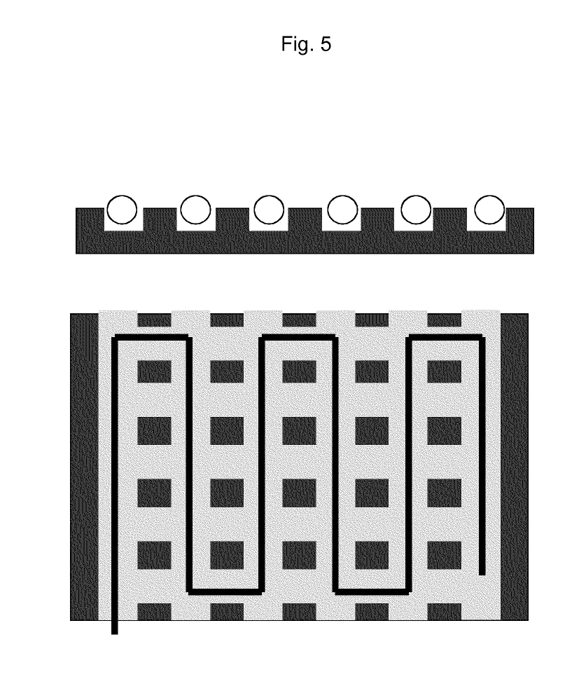

FIG. 5 shows an electrical heater based on coiled electrical resistance wire. This electrical resistance wire can for example be made of Kanthal D with a diameter of 0.6 mm and a resistivity of 1.35 Ohm mm²/m. The wire is coiled to a diameter of 10 mm and with a period of 3 mm between each coil. Six rows of each 8 cm of coiled wire is placed in ceramic channels to give a heater with a resistance of 24 Ohms.

These ceramic channels can be made for example by two in Al₂O₃ foam plates placed on top of each other. The heater wire and ceramic protection is placed inside a metal frame which has a thermal expansion coefficient comparable to the thermal expansion coefficient of the stack. This could be for example Crofer APU. The electrical resistance wire has to be connected to the outside world in a way which avoids leakages through the electrical connections. This can be for example through high temperature ceramic feed-throughs.

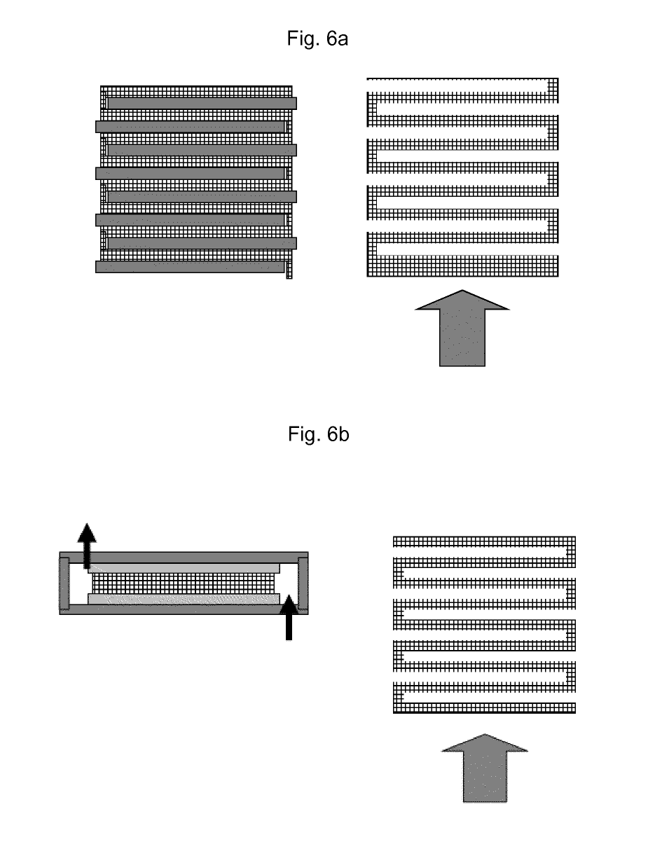

Instead of coiled electrical resistance wire it is also possible to used woven wire cloth for example as shown in FIG. 6a and FIG. 6b. The advantage of the woven cloth is that the heating wires are connected in a mesh, so if one wire breaks there are still many ways for the current to flow.

The electrical heater can also be on a ceramic resistive heater for example in the form of a ceramic resistive heater plate such as those provided by Bach Resistor Ceramics GmbH. These can then be placed in a metal house, which fits the stack mechanics.

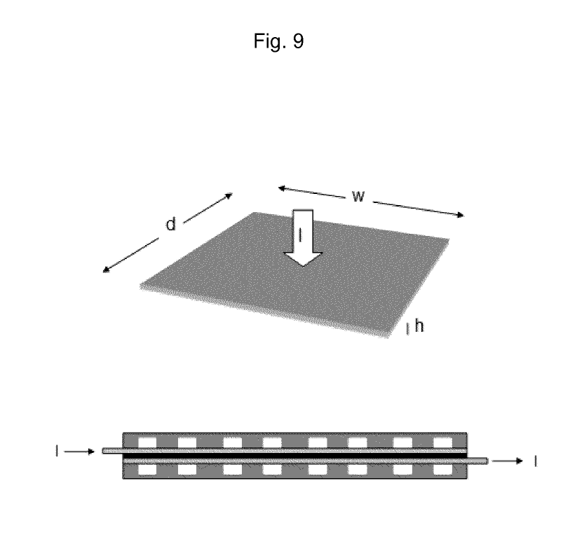

Another embodiment of an electrical heater which is both very compact and avoids the need for ceramic feed-troughs is a planar plate heating element where the current is propagating perpendicularly to the heating plate plane. This is shown in FIG. 9 for a thin heating plate with a width ‘w’ a depth ‘d’ and a height ‘h’, where the current propagate along the ‘h’ axis from the top to the bottom of the plate.

As an example of a realisation consider a heating plate which is designed to match the stack dimensions of 12×12 cm, then both ‘w’ and ‘d’ would be 12 cm. If it is desired to produce 2 kW heat from a 220 V supply, then the resistance of the heating plate should be (220 V)²/2000 W=24.2Ω. If a thin heating plate of 0.3 mm is desired, then the resistivity of the heating plate material should be 0.11 MΩ. Such resistivities are available from a number of ceramics for example SiC, MgO, Al₂O₃ and undoped Cr₂O₃. The desired resistivity can also be realised by mixing two or more ceramics, where on has resisitivity above the desired target value and the other below.

To realise a heating element in a stack, the heating plate could be sandwiched between two metal plates, for example made of the same material used for stack interconnects, such as Crofer APU. The steel plates could each be 0.3 mm thick and have elongations (‘ears’) out side the stack borders for electrical connections. In this way a very compact heater could be realised which would have an open surface area of only 4×12 cm×0.1 cm=4.8 cm² if sandwiched between two stacks. Such a configuration would have a loss ratio of less than 2%

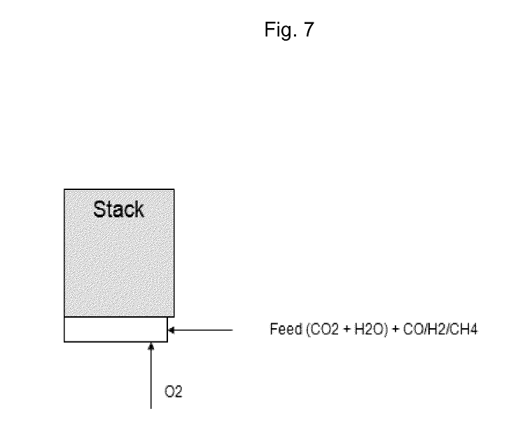

The heater can alternatively be based on chemical heating, typically by injection of burner gas into the system. FIG. 7 shows schematically a heater implemented by feeding a burner gas (e.g. CO, H₂ or CH₄) into the fuel feed stream. Such burner gas might already be found in the fuel feed stream if recycling of the fuel gas is used. At the heater chamber oxygen is combined with the burner gas and combusts.

In a chemical heater configuration the combustion of the burner gas will typically take place when the burner gas temperature exceeds the auto ignition temperature which is close to 600° C. for H₂, CO and CH₄. It is possible to start the combustion at lower temperatures by including a catalyst along the path of the burner gas.

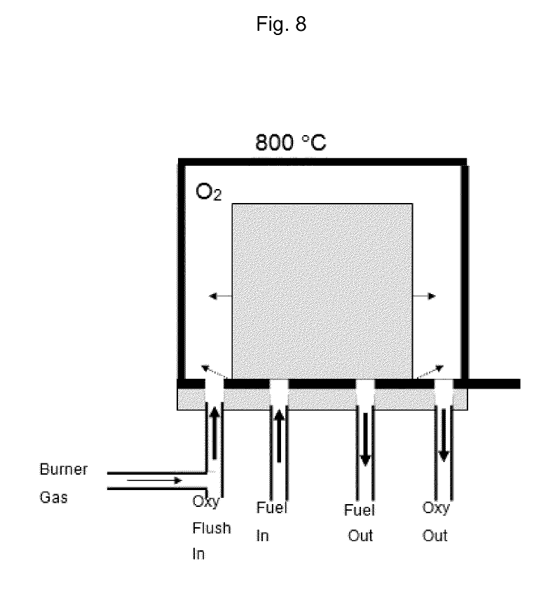

Similar heating functionality can be provided in embodiments, where heating is performed within the oxygen side gas flow. A particular elegant embodiment for external air-manifolded stacks is to insert burner gas into the stack enclosure which typically has a high oxygen concentration as shown in FIG. 8.

On the fuel side the stack is internally manifolded, whereas it is externally manifolded with open cell interfaces on the oxygen side of the stack. On the oxygen side, the stack is flushed with an inert gas (e.g. CO2 or N2) and a burner gas is added to this stream. When the burner gas enters the hot and oxygen rich stack enclosure combustion is instantaneous. The stack temperature can be measured on the stack enclosure or on the output gasses and these temperatures can be used to control the amount of burner gas used.

In an alternative embodiment, the Oxygen side of the stack is not flushed and the pure Oxygen produced by the stack is pushed out of the stack enclosure by the pressure generated by the electrolysis process. In this case burner gas can be feed to the stack as an independent stream.

1. A solid oxide fuel cell system comprising a planar solid oxide fuel cell stack and a heating unit for continuous operation when the solid oxide fuel cell stack is in operation or in stand-by mode, wherein said heating unit is an integrated part of the solid oxide fuel cell system.

2. A solid oxide fuel cell system according to claim 1, wherein the operation temperature of said heating unit is at least the operation temperature of the cell stack minus 50° C., preferably at least the operation temperature of the cell stack.

3. A solid oxide fuel cell system according to claim 1, wherein said heating unit has a ratio between heat transferring loss from surfaces and useful heat transferring to the cell stack of less than 200%, preferably less than 30%, preferably less than 2%.

4. A solid oxide fuel cell system according to claim 1, wherein said heating unit is directly connected to one end plate of the cell stack and wherein the outer dimensions of the connected part of the heating unit corresponds to the outer planar dimensions of said end plate of the cell stack.

5. A solid oxide fuel cell system according to claim 1, wherein said heating unit is arranged at one end of the cell stack and the heating unit is connected to said one end of the cell stack.

6. A solid oxide fuel cell system according to claim 1, wherein the heating unit is arranged between the ends of two cell stacks in a sandwich arrangement.

7. A solid oxide fuel cell system according to claim 6, wherein a plurality, preferably two heating units are arranged between the ends of two cell stacks in a sandwich arrangement.

8. A solid oxide fuel cell system according to claim 1, wherein the heating unit comprises an electrical resistance element.

9. A solid oxide fuel cell system according to claim 8, wherein the electrical resistance element is formed as a planar plate heating element where the current is propagating perpendicularly to the heating plate plane.

10. A solid oxide fuel cell system according to claim 8, wherein the heating unit comprises an electrically isolating element serving to electrically isolate the electrical resistance element from the cell stack.

11. A solid oxide fuel cell system according to claim 1, wherein the heating unit comprises a ceramic resistive heater.

12. A solid oxide fuel cell system according to claim 1, wherein the heating unit comprises a chemical heater.

13. A solid oxide fuel cell system according to claim 12, wherein the chemical heater comprises a catalyst enabling combustion in the chemical heater at a lower temperature than the auto ignition temperature of a burner gas provided to the chemical heater.

14. A solid oxide fuel cell system according to claim 1, wherein said heating unit is placed in the vicinity of the manifolding where the process gas enter the cell stack whereby the heating unit heats up the process gas entering the cell stack which results in a uniform heating of the cell stack.

15. A solid oxide fuel cell system according to claim 14, wherein said heating unit is placed between two manifolds for process gas and said two manifolds are arranged between the ends of two cell stacks in a sandwich arrangement.

16. A solid oxide fuel cell system according to claim 1, wherein said heating unit is formed by an external manifolding for a process gas for the cell stack and the heating is performed by adding a burner gas to the process gas in the external manifolding.

17. A solid oxide fuel cell system according to claim 14, wherein the manifolding is for a process gas on a cathode side of the SOFC cell stack.

18. A solid oxide fuel cell system according to claim 14, wherein the manifolding is for a process gas on an anode side of the SOFC cell stack.
